(19) United States
(12) Patent Application Publication
(10) Pub. No.: US 2009/0238379 A1
(43) Pub. Date: Sep. 24, 2009

(54) APPARATUS AND METHOD FOR MINIMIZING QUANTIZATION NOISE AS MUTING

(76) Inventor: Lo-Tien FENG, Taipei City (TW)

Correspondence Address: BIRCH STEWART KOLASCH & BIRCH, PO BOX 747, FALLS CHURCH, VA, 22040-0747, US

(21) Appl. No.: 12/144,464

(22) Filed: Jun. 23, 2008

(30) Foreign Application Priority Data
Mar. 20, 2008 (CN) 200810086748.2

(51) Int. Cl. H04B 15/00

(52) U.S. Cl. 381/94.5

(57) ABSTRACT

An apparatus and method for minimizing the quantization noise as muting are provided, and particularly applied to a Delta-Sigma modulator that is used to process digital-to-analog conversion. By means of a zero-sampling detection circuit and a dynamic gain mechanism, a dynamic gain is introduced to minimize the quantization noise occurred as muting. The method preferably includes a first step for receiving the signals by the Delta-Sigma modulator inputted from an audio decoder, and a next step for detecting signal zero by a zero-sampling detection unit and counting the number of the signals with signal zero. The mute state is entered when the number of signal zeros reaches a pre-set number. At the moment, the signaling route is switched to another route with dynamic gain mechanism. Further, the dynamic gain mechanism is activated for producing a dynamic gain, which will be fed back to the input end of the modulator.

### BACKGROUND OF THE INVENTION

1. Field of the Invention

The present invention relates to an apparatus for minimizing quantization noise as muting and method, and more particularly, to minimize the quantization noise by utilizing a dynamic feedback gain control.

2. Description of Related Art

All the conventional music players have the digital-to-analog converters (DAC) which are used to convert the digital audio signal into analog audio signal. Furthermore, most digital-to-analog converters adopt a Delta Sigma Modulator (hereafter briefed as DSM), in which a noise shaping technology is used to reduce the background noise and to improve the sound quality during conversion.

Some situations occur when the music player having the DSM for reducing the noise plays music, as follows. The music player plays a very good muting state in the very beginning of playing music or simply playing mute after resetting the digital-to-analog converter. Besides, the music player would produce uncomfortable and un-predictable noise during the period between the end of music and start of next music, or the muting period after playing the music, or the period of the DSM enters signal zeros. In the meantime, the phenomenon will let the measurement of the signal-noise-ratio (SNR) be inaccuracy.

In fact, the music player outputs larger magnitude of the quantization noise with the muteness after playing some music than the muteness playing initially. The former case sometimes makes users feel uncomfortable.

Please refer to FIG. 1A and FIG. 1B. FIG. 1A shows the relation with an ideal amplitude and time when the conventional music player playing mute. The horizontal axis represents progressive time, and the vertical axis is for amplitude. As shown, the ideal (standard) amplitude is zero when the music player plays mute, and there is no noise other than the amplitude zero as the time progresses.

Next, the FIG. 1B shows the relation with the amplitude and time during the muting interval between two songs as playing music. The horizontal axis also represents progressive time, and the vertical axis is also for amplitude. When entering the muting state after music, entering the muting interval, or outputted signal being zero, the noise meaning that the amplitude is not zero is produced.

Reference is made to FIG. 2 which shows an electrical block diagram illustrating the linear model of a 3-order Delta-Sigma modulator (DSM), hereafter briefed as 3-order DSM, which is applied to an audio digital-to-analog converter. The shown 3-order DSM is composed of a plurality of adders 201, 202, 203, 204 and 205, some integrators 206, 207 and 208, and some gain generators used to provide the tunable gain coefficients a1, a2, c1, c2 and g1, and further a quantizer. The mentioned adder 205 is used to present the quantization noise introduced by the quantizer.

The mentioned gain coefficients, which are tuned by a coefficient multiplier, can be fed back from the output end of the modulator to the input end of each adder. The gain coefficient g1 is used to tune the signal generated by the integrator 208, and the signal is fed back to the adder 203. In this circuit, the coefficients c1 and c2 are also introduced to the tune the signals so as to achieve the required response in the frequency domain. Further, the quantizer is used to quantize the output data of the integrator 208. The quantization noise represented as function E (z) is produced during the process of quantization. The quantization noise is introduced into system by the adder 205 for analyzing as a linear model. Consequently, the output data from the adder 205 is processed by a delay unit 209 and the audio digital-to-analog conversion is accomplished.

Above-mentioned adders 201, 202, 203, 204 and 205 perform an adding operation on every data received from the units connected with the adders, including the data after quantization or multiplication, or the data from the coefficient multipliers (multiplied by coefficients a1 and a2). Each integrator 206, 207 or 208 is composed of the adder (not shown) and delay unit (not shown), so as to accumulate the data outputted from the mentioned adders. Further, the coefficient multiplier is to multiply to the quantization data (the quantization noise through the delay unit) by a coefficient (a1 or a2), and then transmit the data to the adders.

The value X (z) is the digital signal inputted to this 3-order DSM 20, and the value Y (z) is the analog signal outputted from the 3-order DSM 20, and the value E (z) represents the quantization noise introduced by the adder 205. This simulated quantization noise influences the input value X (z). As to the digital audio, the integrated waveform of value Y (z) as far as close to the inputted value X (z), and then the better SNR and quality can be obtained. Apparently, if the quantization noise E (z) of the output value Y (z) can be reduced, the better SNR and quality can be obtained.

According to the mentioned 3-order Delta-Sigma modulator, a transferring function is deduced as formula (1):

Y(z)=STF(z)·X(z)+NTF(z)·E(z) (1)

Wherein, the X(z) is the input value of modulator, E(z) is the quantization noise, STF(z) is an input signal filter, NTF(z) is a quantization noise filter, and Y(z) is the output value of the modulator.

In the embodiment of this modulation system, STF (z) is implemented as a low-pass filter (LPF) or all-pass filter, and NTF (z) is a high-pass filter (HPF). The above-mentioned gain coefficients a1, a2, g1, c1 and c2 are configured and used to be the parameters for the filters. As playing mute, the input value of the modulator is zero, so that STF (z) can be ignored since STF (z) has no weight at the output of the modulator. However, the frequency response of NTF (z) will affect the magnitude of the output signal. If the quantization noise of the output signal is too strong, the mute noise will be produced.

Since the modulation system produces different level of the quantization noise as the muting state enters under different conditions, the prior art provides the way to improve the audio quality during the conversion. Namely, in order to improve the quality as converting the signals, a noise shaping technology in the modulator is used in the prior art for reducing the noise.

Usually, two approaches are provided to solve the above problem, which derives an uncertain SNR performance and listens to some uncomfortable noise while muteness after playing some music, as follows:
1. Firstly, a dither mechanism is disposed at the output end. Reference is made to U.S. Pat. No. 6,515,601, which is issued on Feb. 4, 2003, providing a noise shaper applied to the digital audio conversion. A dither adder is disposed before a quantizer in the noise shaper and introduced to generate dither signal for suppressing the idle pattern. But this approach will decrease the measurement of the audio SNR and increase the cost of design, and the users will hear some white noises as playing mute.
2. Secondly, all the operative registers (in integrator) disposed on the modulator are reset as starting to play mute. Since the buffers are reset to zero in this approach, a pop noise will be produced as changing the magnitude of the output signal instantly.

### SUMMARY OF THE DISCLOSURE

In response to the above conventional modulation, signal zero can be obtained as simply playing mute, but some uncomfortable noises will come out as muting after playing music. In the meantime, audio SNR (signal-noise ratio) under different conditions for measurement causes error. Since the audio signal transmitted from a digital audio decoder to the Delta-Sigma modulator is zero in the beginning, the mute with signal zero can be obtained. Nevertheless, because the data stored in an operative buffer of the modulator changes after playing the music rather than the state of the buffer as simply playing mute, the magnitude of the outputted quantization noise will be too strong as playing mute.

In view of the above-mentioned drawback, the present invention provides an apparatus and method for minimizing quantization noise as muting. Especially, a dynamic feedback gain is adopted to produce high-quality mute without further change of the whole structure of the modulation system. The preferred embodiment of the method for minimizing quantization noise as muting includes a first step for receiving the signal inputted from an audio decoder by a Delta-Sigma modulator. The next step is to detect the inputted signal by a zero-sampling detection unit disposed on the modulator, and the signal zeros are counted and accumulated. A mute state is determined to be entered since the accumulated number of the successive signal zeros reaches a pre-set number. Next, the signaling route is switched to the route with the dynamic gain mechanism, and the dynamic gain mechanism is activated for producing a dynamic gain. The dynamic gain is fed back to the input end of the Delta-Sigma modulator.

Particularly, a lookup table is introduced as activating the dynamic gain mechanism, and the dynamic gain for each time is defined in the lookup table. Further, a fade-out effect and a fade-in effect are obtained by successively changing the dynamic gain for suppressing the pop noise occurred as converting the audio signal.

The apparatus of the present invention at least includes a Delta-Sigma modulator, which is used to receive the audio signal inputted from an audio decoder and post-processor, and execute a digital-to-analog conversion. The apparatus further includes a module for producing a dynamic gain, which preferably is implemented by a lookup table. The means is to produce the dynamic gain fed back to the input end of the modulator for tuning the inputted signal. The apparatus further includes a zero-sampling detection unit that is coupled to the input end of the modulator for detecting the inputted signal and counting the signal zeros. When the number of the accumulated signal zeros reaches a pre-set number, a mute state is entered and the dynamic gain mechanism is activated.

In particular, the mentioned Delta-Sigma modulator is formed as a 3-order Delta-Sigma modulator composed of a plurality of integrators and adders. When the mute state enters, a multiplexer is used to switch the signaling route to the route with the dynamic gain mechanism.

### BRIEF DESCRIPTION OF DRAWINGS

The present invention will be readily understood by the following detailed description in conjunction accompanying drawings, in which:

FIGS. 1A and 1B are the charts of the volume magnitude as playing mute;

FIG. 2 is a block diagram illustrating the circuitry of a noise shaper in accordance with the conventional art;

FIG. 3 shows a conceptual diagram of the apparatus for minimizing quantization noise of the present invention;

FIG. 4 shows a schematic diagram of the apparatus of the preferred embodiment of the present invention;

FIG. 5 shows the frequency response for the quantization noise under variant dynamic gain values;

FIG. 6 shows the frequency response for the quantization noise under variant dynamic gain values;

FIG. 7A and FIG. 7B show the experimental result of the present invention using the dynamic feedback gain (g=1) to minimize the quantization noise;

FIG. 8A and FIG. 8B show the experimental result of the present invention using the dynamic feedback gain (g=4) to minimize the quantization noise;

FIG. 9A and FIG. 9B show the experimental result of the present invention using the dynamic feedback gain (g=8) to minimize the quantization noise;

FIG. 10 shows a diagram of the experiment adding the fade-in and fade-out effect;

FIG. 11 shows a flow chart of the method for minimizing the quantization noise of the present invention.

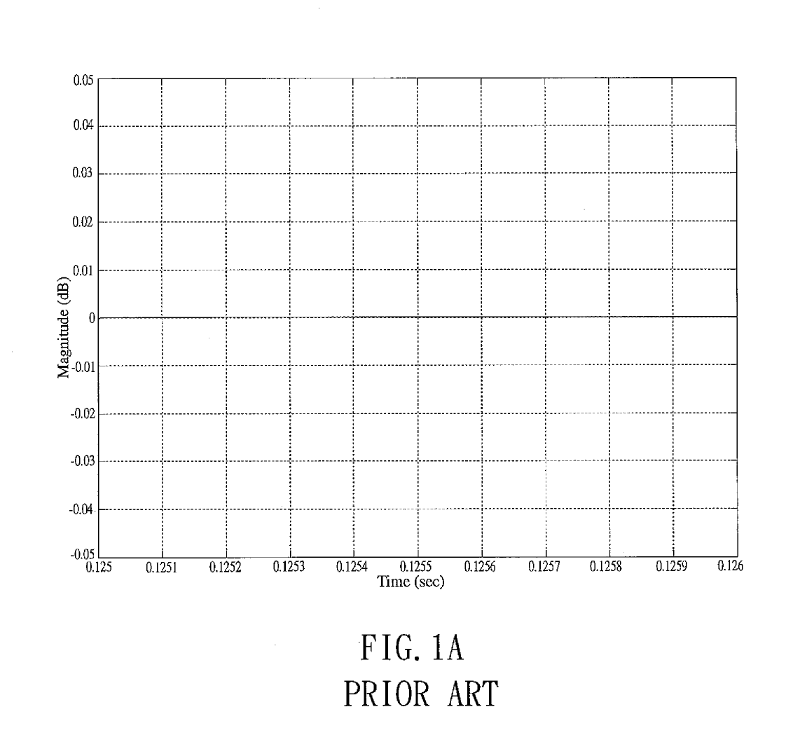

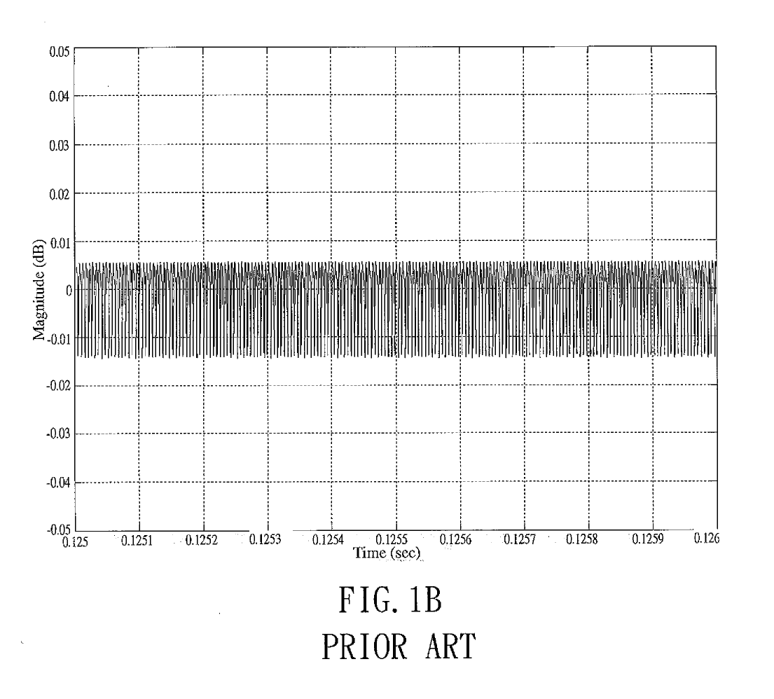

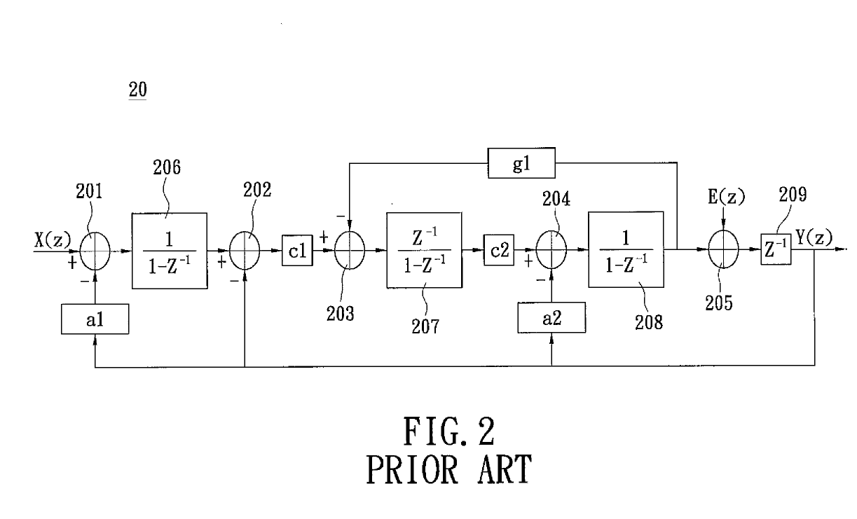

### DETAILED DESCRIPTION OF THE PREFERRED EMBODIMENTS

To understand the technology, means and functions adopted in the present invention further, reference is made to the following detailed description and attached drawings. The invention shall be readily understood deeply and concretely from the purpose, characteristics and specification. Nevertheless, the present invention is not limited to the attached drawings and embodiments in following description.

In view of the current multi-order Delta-Sigma modulator adopted by the audio decoder, the conditions are different as playing mute (ideal muting) before playing music and after playing music. That is, the signal zero can be obtained as simply playing mute, such as before the time as starting to play music; but uncomfortable noise will be produced during the time period after the end of last music and ready to play next one. Since the condition of an operative buffer disposed on the modulator as playing mute after ending last music is different from the condition of ideally playing mute, the outputted quantization noise will be too strong as playing mute. The object of the present invention is to introduce a dynamic feedback gain to producing high-quality mute without further change of the whole modulation system.

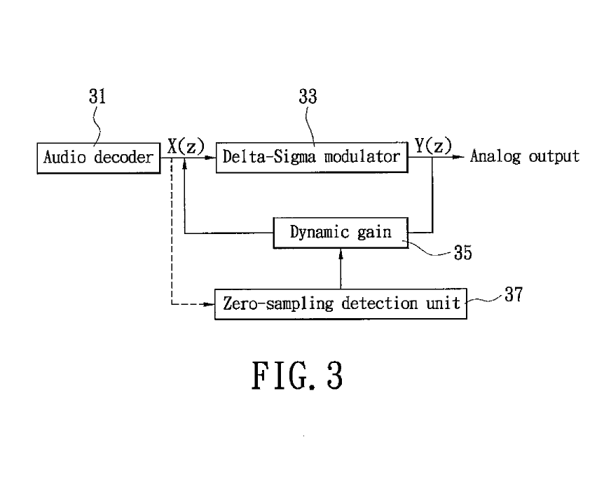

Reference is made to FIG. 3 showing a conceptual diagram of the apparatus for minimizing quantization noise as muting. A Delta-Sigma modulator (hereafter briefed as DSM) 33 is incorporated into an audio decoder, which receives the digital signals X (z) sent from an audio decoder 31. The Delta-Sigma modulator 33 performs the signal processing, converts the signals, and outputs the signals Y (z) to the posterior circuit. The inputted signal from the audio decoder 31 should not be zero as playing music, but the inputted signal from the decoder 31 will be zero as muting.

Since the object of the present invention is to minimize the quantization noise, a dynamic gain mechanism is introduced to tune the magnitude of the inputted signals as muting. The mentioned dynamic gain is preferably generated by a dynamic gain generating module. For example, a signal generating circuit (not shown) disposed on the DSM 33 can be implemented to generate the dynamic gain, or a lookup table is used to obtain the dynamic gain in a preferred embodiment. Particularly a zero-sampling detection unit 37 is incorporated into detecting the signal before the signal enters the DSM 33. Further, this zero-sampling detection unit 37 having a counter to count the zero signals. When the accumulated zero signals reach a predetermined number, it is determined that it enters a mute period. In the meanwhile, the dynamic gain mechanism is activated. The signals processed through the DSM 33 will be tuned based on the dynamic gain 35, which is to tune the magnitude of the signals for minimizing the quantization noise.

When the DSM 33 is modulated under the dynamic gain to let the output value and the received signals approach an ideal state, the zero-sampling detection unit 37 stops controlling the dynamic gain's circuit for recovering the dynamic gain as 1. So the stability of DSM 33 won't be influenced, and its accuracy will be preserved. This dynamic gain mechanism won't be activated until the next mute state is entered.

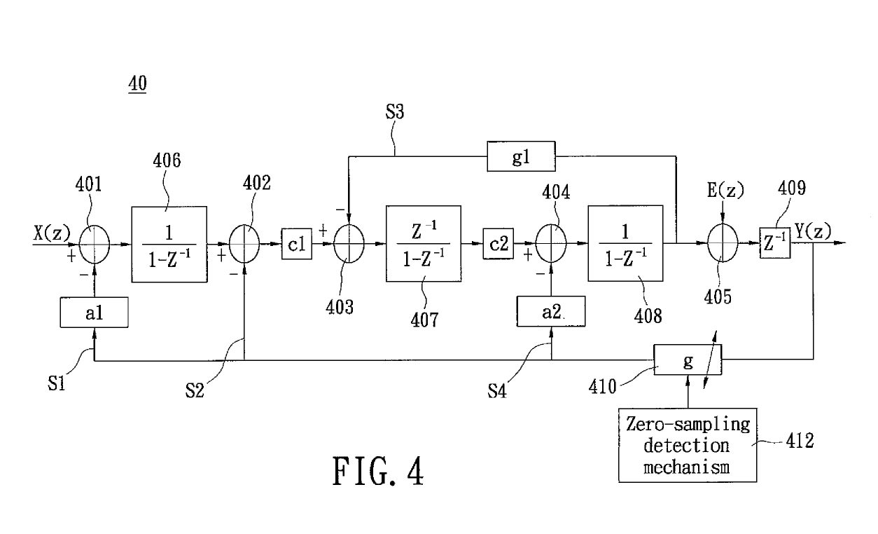

More detailed description is given of a preferred embodiment of the present invention with reference to FIG. 4. The block diagram of the Delta-Sigma modulator 40 shown in the figure is incorporated into an audio decoder, the digital-to-analog converter. The modulator 40 is a 3-order Delta-Sigma modulator 40 having a plurality of integrators 406, 407 and 408, and adders 401, 402, 403, 404, and 405. Furthermore, the modulator 40 also includes a delay unit 409 for achieving the systematic transferring function. Particularly, a dynamic feedback gain mechanism (410) is introduced to this Delta-Sigma modulator 40 for feeding back the output value of this modulator 40 to the input end thereof. In this embodiment, the adders 401, 402 and 404 will receive this dynamic feedback gain (410) for eliminating the quantization noise as muting by the dynamic gain.

The dynamic feedback gain mechanism is to use a zero-sampling detection unit 412 to detect the digital signal X (z) inputted to this modulator 40. The zero-sampling detection unit 412 equips a circuit for counting the signal zeros, and couples to the input end of the modulator 40. When the zero-sampling detection unit 412 determines that the number of the detected signal zeros is accumulated to reach a pre-set number (predetermined number), it shows the time to play mute. In the meanwhile, a dynamic feedback gain mechanism is activated. The gain fed back to the input end is tuned dynamically based on the status of quantization noise. Therefore, the magnitude of the signal in mute transmitted through the Delta-Sigma modulator 40 is tuned for minimizing the quantization noise. After the modulator 40 undergoes the dynamic gain modulation, the zero-sampling detection unit 412 stops controlling the signal generating circuit of the modulator 40 when the output of the received signal zeros is modulated as approaching an idea value. Next, the dynamic gain is reverted the output to 1 in order to keep the modulator 40 from unnecessary influence, and to hold the accuracy of the modulation mechanism. The mentioned dynamic gain mechanism won't be re-activated until the next mute sate is entered.

In view of the embodiment of the Delta-Sigma modulator 40 shown in FIG. 4, the signal X (z) is inputted to the modulator 40, and being processed through the Delta-Sigma modulation. The inputted signal X (z) is inputted to the adder 401, and the adder 401 performs an adding operation on the inputted signal and a received first feedback signal (S1) that multiplied by coefficient a1. This first feedback signal (S1) is the former signal went through the modulator 40 and fed back after quantization and delay operation.

Next, the integrator 406 integrates the signal, and outputs it to the adder 402. The adder 402 performs the adding operation on the signal outputted from the integrator 406 and a second feedback signal (S2) shown on the figure. After that, the signal are tuned by multiplying the coefficient cl and inputted to the adder 403. Meanwhile, the adder 403 performs the adding operation on the signal and a third feedback signal (S3) which is the former signal fed back through the integrator 408 and multiplied by coefficient g1. Next, the signal is transmitted to the integrator 407 which performs integration such as the signal filtering procedure.

After that, the signal is multiplied by the coefficient c2, and inputted to the adder 404. The adder 404 receives a fourth feedback signal (S4) which is fed back from the output end and multiplied by the coefficient a2. Next, the adder 404 performs the adding operation on the signal and the signal after multiplied by the coefficient a2. Then, the signal is transmitted to the integrator 408 for operating integration. More, a quantizer (not shown) is incorporated to quantize the output value of the integrator 408, then the generated quantization noise, presented as the function E(z), is introduced to the system through the adder (or substituted for a comparator) 405 for further linear model analysis. At last, the digital to analog conversion is achieved since the output data of the adder 405 of this embodiment is tuned by the delay unit 409 implemented by delay circuit.

In practice, when the zero-sampling detection unit 412 detects the signal zero, the signal “detect” or signal “finish”, that indicates the start and end of mute detected respectively, will be generated. When the signal zeros are inputted from the audio decoder and being accumulated to a pre-set number, a signal “detect” is generated. It is determined that a muting period is entered, meanwhile, a multiplexer (not shown) is used to change the signaling route, and the dynamic feedback gain is introduced into modulator 40. Next, when the non-zero signal enters, that means the period of mute ends, and a signal “finish” is generated at this moment. Meanwhile, the multiplexer is used to switch the route to the original one. Additionally, when the output of the signal zero is standardized by the modulator 40 since the “finish” signal is generated, the signaling route is back to the original one after a fade-in effect.

There is another way to derive the ideal muteness, after finishing the procedure of minimizing the quantization noise using the dynamic gain, it means the mute state ends. At this moment, the zero-sampling detection unit 412 stops controlling the signal generating circuit of the modulator 40, and resets the dynamic gain to 1 for avoiding the accuracy of the modulation. The dynamic gain mechanism won't be activated until the next mute state is entered.

According to the mentioned preferred embodiment of the present invention, the mechanism of the dynamic gain is controlled by the zero-sampling detection unit, so the embodiment of the dynamic gain mechanism will not increase the cost of the modulator. For example, the gain value g can be implemented by hardware with power-law exponent 2. Therefore, the gain calculation is accomplished as muting only by adjusting the position of decimal point, but not increasing the original length of operative bit.

Based on the transferring function described in formula (1), since the dynamic feedback gain provided by the dynamic gain mechanism of the present invention is introduced into the analysis of the quantization noise filter function NTF(z), the output attenuation of the audio signal in NTF(z) is getting bigger as the gain value is bigger. The above result corresponds with the requirement for minimizing quantization noise as muting.

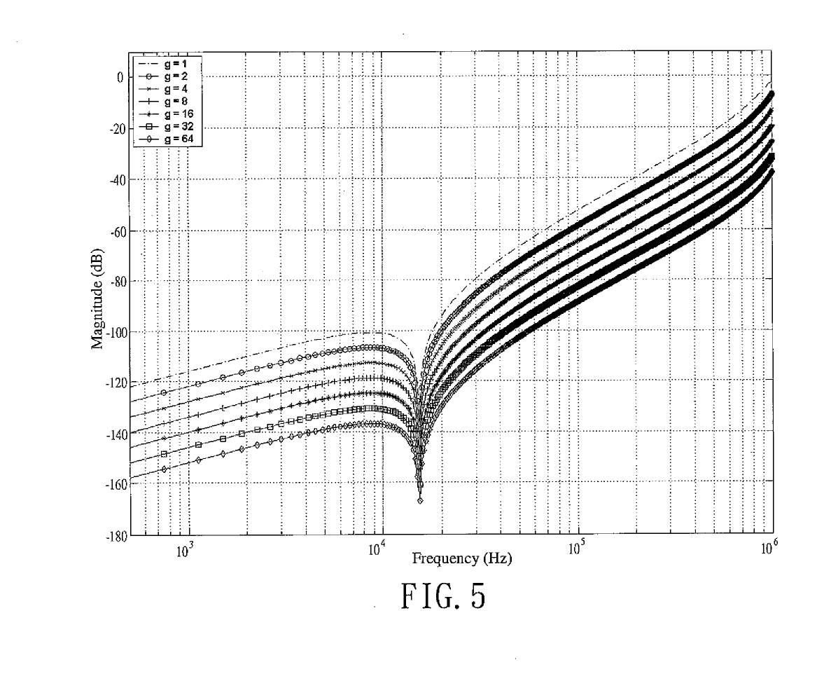

For introducing the dynamic gain to the analysis of the quantization noise filter function NTF (z), the experimental result shown in FIG. 5 is obtained. FIG. 5 shows a relation (frequency response) between the intensity of the filter noise (dB) and the frequencies (500-2 MHz). In this range of frequency, no matter whether in higher frequency or lower frequency, the magnitude of noise minimized by the filter is weaker as the gain g is bigger. Such as the shown curves change as gain value changes as 1, 2, 4, 8, 16, 32 and 64, and the depressed magnitude of the quantization noise changes. The effect of the present invention for minimizing the quantization noise is proved.

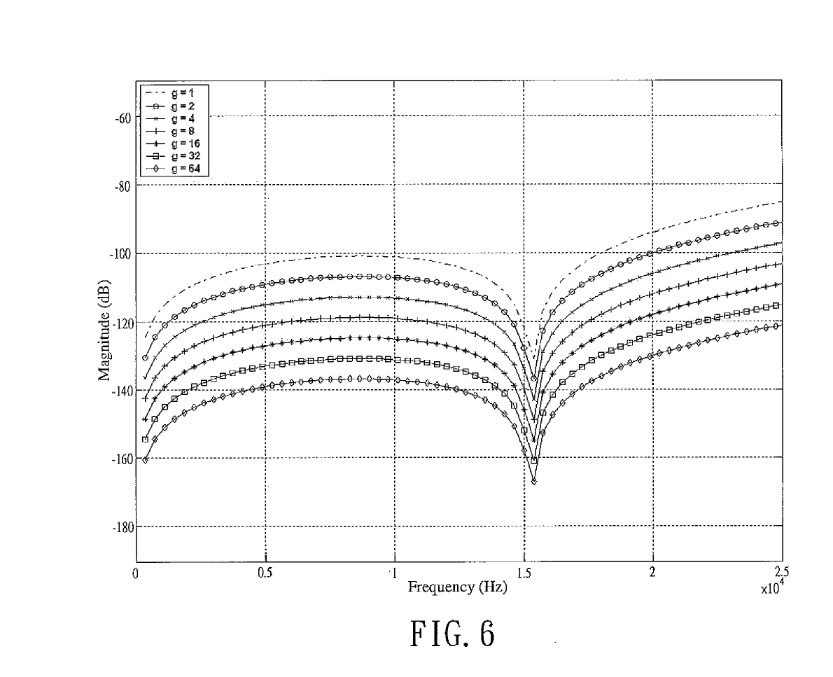

FIG. 6 shows the change of the frequency response of the quantization noise filter (NTF (z)) in the audio frequency ranging from 0 to 25 KHz. The curves shown in figure also prove that the quantization noise is obviously minimized as the gain value g becomes bigger.

According to the above-mentioned experimental result, the output of the quantization noise filter function NTF (z) attenuates more as the gain value g is bigger. The result agrees with the expectation of quantization noise reduction of the present invention. In hardware, the dynamic feedback gain mechanism is implemented by controlling the zero-sampling detection in the digital decoder without any increment of cost of the modulator, but only increases the number of multiplexers disposed on the route for transmitting operation data.

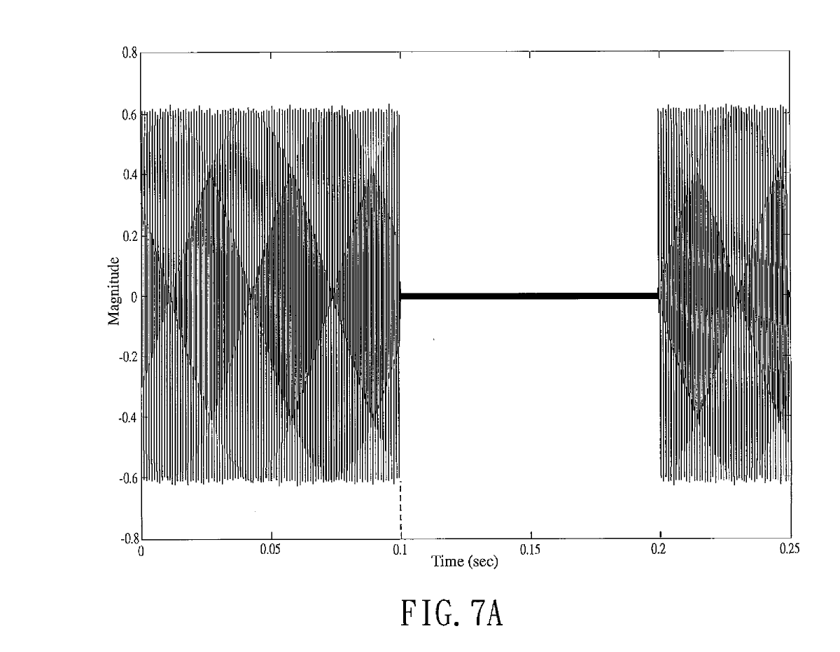

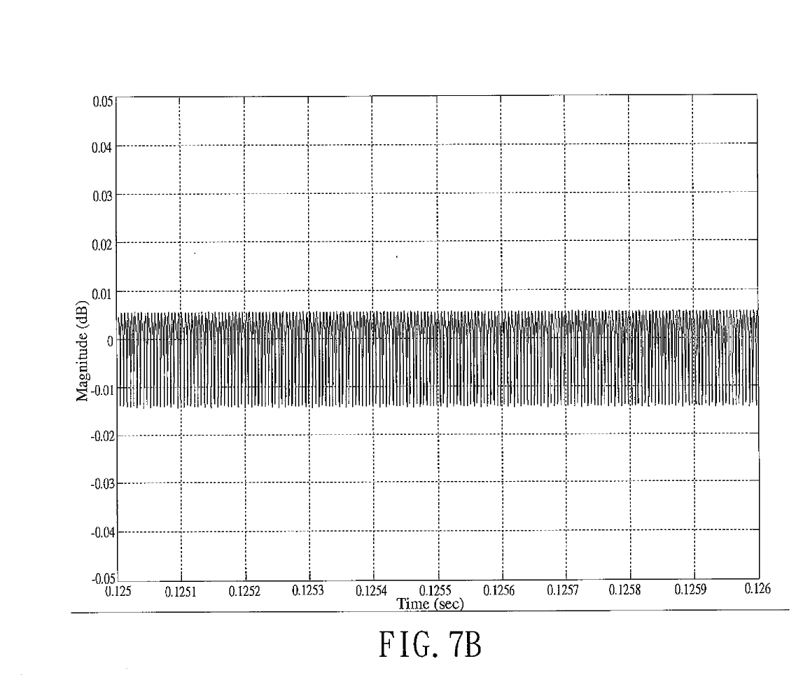

FIG. 7A shows an experimental result of the present invention using the dynamic feedback gain to minimize the quantization noise. The gain equals to 1 in this embodiment. In the time domain of the embodiment, a specific magnitude of the audio signal occurs during the time 0 second through 0.1 second, which means there has music or sound produced in this period. After the time 0.1 second, the volume is obviously minimized as the magnitude drops to 0 around. In the meanwhile, a mute state is simulated in this experiment. The mute ends after the time 0.2 second, and the magnitude recovers to the original state.

The mentioned gain value 1 indicates no gain is produced. Reference is made to FIG. 7B showing the magnitude during the time 0.125 second through 0.126 second that is extracted from the above-mentioned diagram when the gain value equals to 1. After magnifying the part of the period, the amplitude of the volume shown in this period is about 0.02 (the result of normalization equaled to −34 dB), that means noise is produced there between.

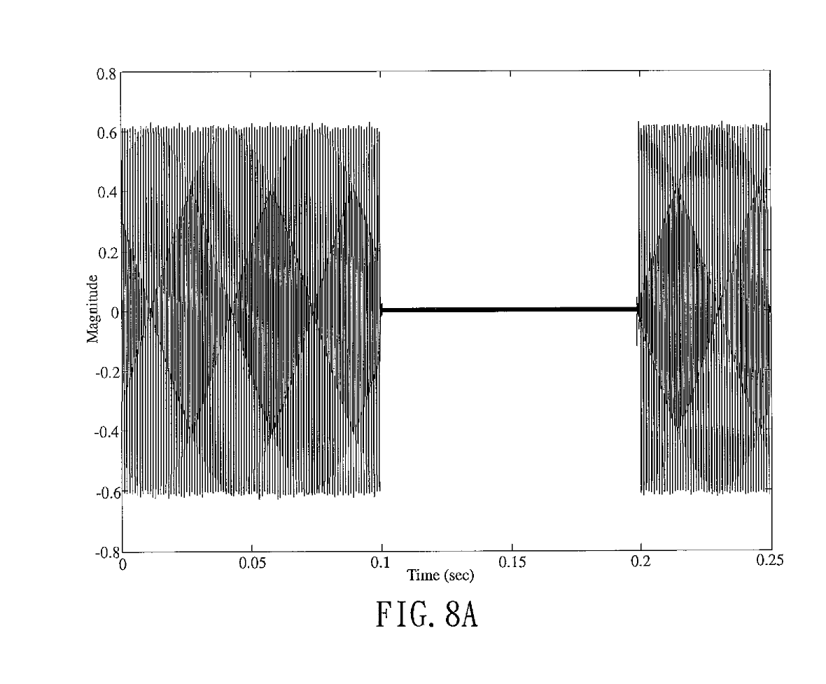

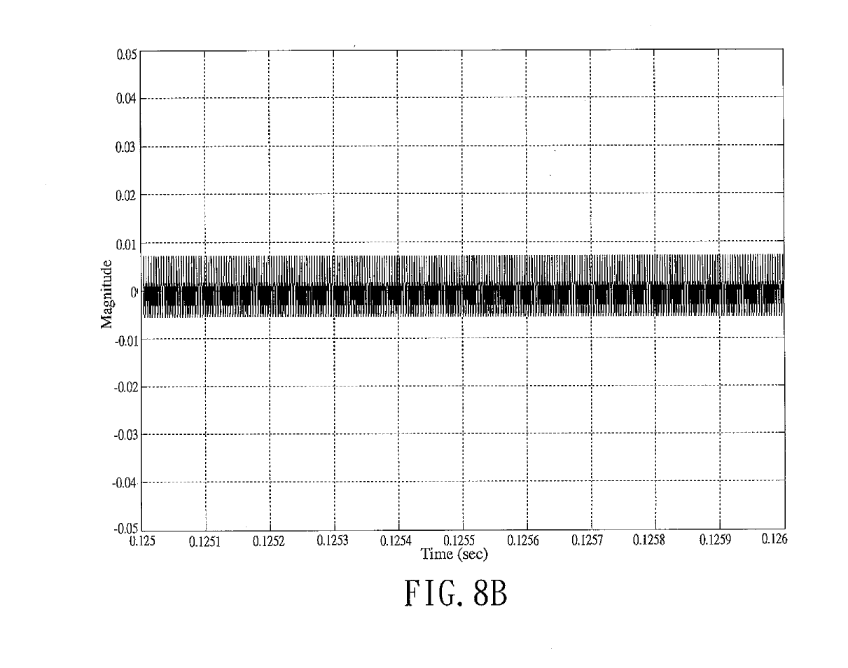

FIG. 8A and FIG. 8B show the experimental result of the present invention using the dynamic feedback gain to minimize the quantization noise. In FIG. 8A, the magnitude of audio signal is kept at a specific magnitude from time 0 second through 0.1 second, it shows music or sound is produced. After the time 0.1 second, the magnitude drops down to 0 around and enters a mute period. The gain value is 4 in this embodiment. The magnitude recovers to the original magnitude after the time 0.2 second.

Reference is made to FIG. 8B, which magnifies the part extracted from the mute period from 0.125 second through 0.126 second as the gain value is 4 shown in FIG. 8A. After comparing with the result shown in FIG. 7B, the quantization noise with gain value 4 is weaker than the noise with gain value 1. The magnitude in mute period with gain value 4 drops obviously, and amplitude thereof is smaller than 0.02 (the result of normalization equaled to −40 dB).

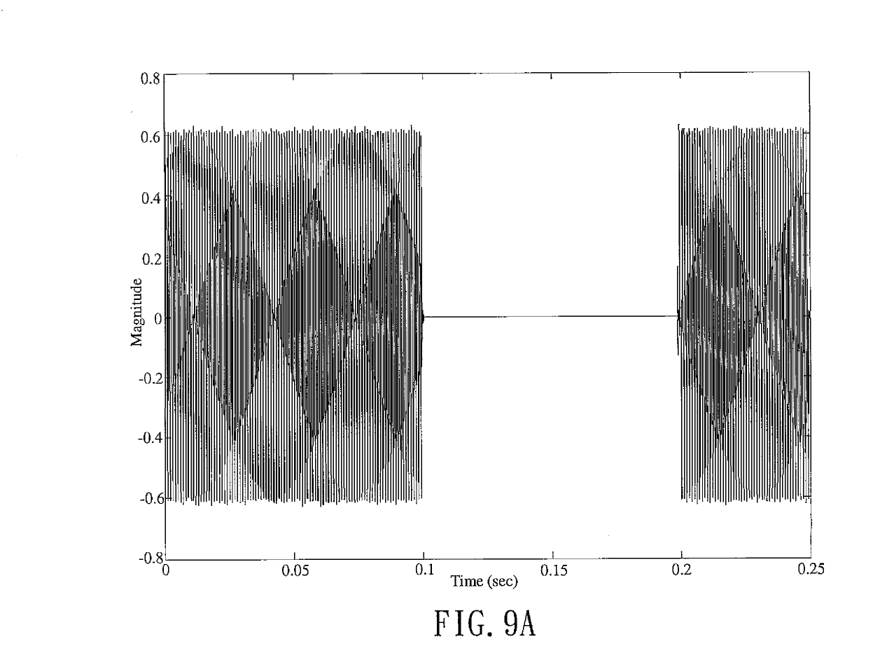

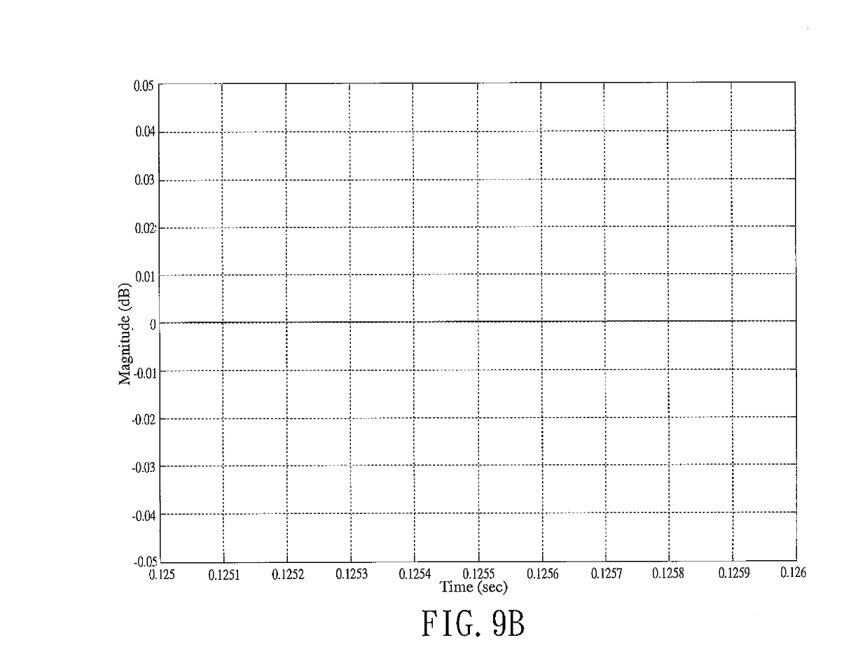

FIG. 9A and FIG. 9B show the experimental result of the present invention as the gain value equals to 8. FIG. 9A shows the magnitude of the audio signal with gain value 8. The time 0 second through 0.1 second is non-mute period with a specific audio magnitude. The magnitude drops approaching 0 around at the time 0.1 second and a mute period is entered. After that, the magnitude is recovered to original state at the time 0.2 second.

FIG. 9B shows the audio magnitude of a magnified part of the mute period shown in FIG. 9A from time 0.125 second through 0.126 second. Rather than the experiment result shown in FIG. 7B and FIG. 8B, the noise in mute period can almost drop to 0 as the gain value is 8.

Accordingly, the dynamic gain provided by the present invention can affect the signal in the mute period apparently. Further, the bigger gain can minimize the noise more and more. According to the conventional art, since the amplitude changes rapidly, the users will feel uncomfortable as the pop noise produces. Under the mentioned condition, the dynamic gain mechanism of the present invention is provided to add the fade-out and fade-in effect respectively at the time from non-mute state transferring to mute state and the time from mute sate transferring to non-mute state, so as to suppress the pop noise.

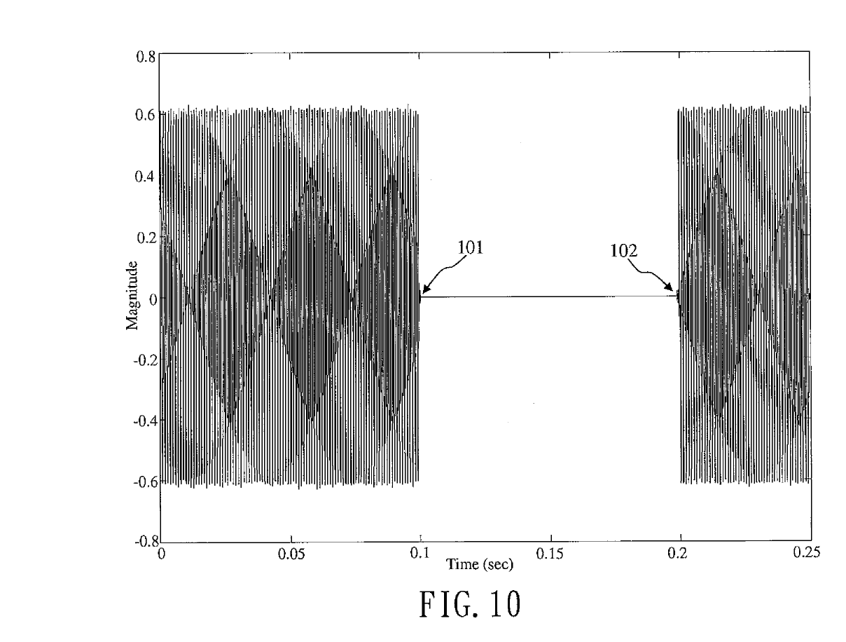

FIG. 10 shows a diagram of the experiment adding the fade-in and fade-out effect. The mute period starts at the time 0.1 second and ends at the time 0.2 second. For suppressing the pop noise, a successive dynamic gain is introduced into the time from the non-mute state transferring to the mute state, such as the region 101, thereby to produce a fade-out effect by dynamically and successively changing the gain to decrease the magnitude until mute. On the other hand, the region 102 shows the period from the mute state transferring to the non-mute state. The fade-in effect is produced to increase the magnitude by dynamically and successively changing the gain for minimizing the pop noise. Afterward, the period to play sound is entered.

According to the preferred embodiment, the gain change is based on a lookup table. When the zero-sampling detection unit detects continuous signal zeros, the mute period is entered. The dynamic gain mechanism activates. The gain for each time can be obtained through the lookup table, and thereby to produce the fade-out effect and enter the mute.

When the mute ends according to the detection, the dynamic gain mechanism activates again. The gain for each time can also be obtained through the lookup table, and it's to produce the fade-in effect by successively changing the gain and enter the period of playing sound. At this moment, in order to avoid any possible influence on the stability of modulation circuit due to the changed gain, the zero-sampling detection circuit will stop controlling the signal generating circuit after the period of playing sound ends under the fade-in effect finishing. After that, the dynamic gain is recovered as 1, and the dynamic gain mechanism won't be activated until the next mute state is entered. Beside the fade-in/fade-out effects' scheme, there is another way to derive the ideal mute. After producing the fade-out effect via controlling the dynamic gain's circuitry, an ideal mute is obtained in the muting period, the zero-sampling detection unit stops controlling the dynamic gain that is recovered as 1. The later approach ensures the stability of the modulator won't be influenced by the dynamic gain in the non-mute state, but the fade-in effect won't be attained to after muting.

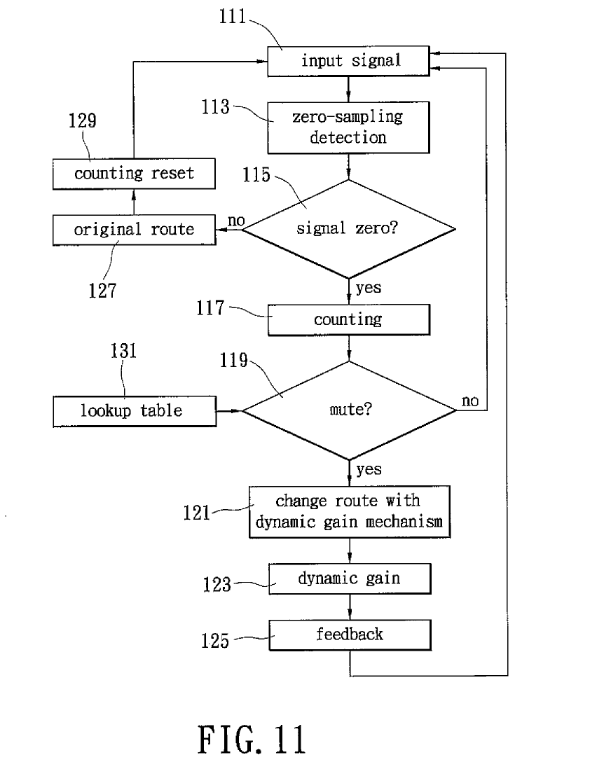

The Delta-Sigma modulator of the present invention is employed the dynamic feedback gain mechanism to minimize the quantization noise, the method thereof is shown as the flow in FIG. 11.

In the beginning, the Delta-Sigma modulator receives the signal inputted from an audio decoder (step 111), such as the inputted digital signal. Next, the zero-sampling detection unit disposed on the modulator detects the signal 0 (step 113). Next, the zero-sampling detection unit determines whether the inputted signal is zero or not (step 115). If the inputted signal is not zero, that will be 1 for the digital signal, in which the signal is regarded as a regular audio signal. Meanwhile, the signal is under the conversion operation via the original modulating route (step 127). Further, the accumulative number counted in step 117 will be reset (step 129). After that, the steps will go to the step 111 for sustaining signal zero detection.

If the inputted signal is zero, the counting step is operated, and accumulating the number of signal zeros (step 117). Next, the method determines whether the mute period is entered or not. In the preferred embodiment of the present invention, the method uses the accumulated number of the successive signal zeros to determine whether the mute period is entered or not (step 119). Particularly, the method doesn't regard as the period is mute until the successive signal zeros are accumulated to a specific number, so as to reject the other noises. If the accumulated data does not reach the specific number, not mute, and then the method goes back the step 111 for further detection.

If the successive signals are accumulated to the specific number, the mute period is entered. In the preferred embodiment of the present invention, one or a plurality of multiplexers are used to switch to the route with the dynamic gain mechanism (step 121). At this moment, the dynamic gain mechanism is activated (step 123). Further, a lookup table (131) is introduced in a preferred embodiment. By means of the lookup table, the gain for each time in the mute period can be defined and be fed back to the input end of the modulator (step 125), thereby to tune the signal.

According to the preferred embodiment, at the moment of playing sound transferring to playing mute, a signal for activating the dynamic gain mechanism is generated, such as a detect signal. By means of the lookup table, the gain value will be changed successively to produce a fade-out effect, so as to prevent the pop noise. Further, the gain value in the mute period can be determined circumstantially. Next, if the mute ends and the non-mute starts, that means the state of successive signal zero ends, the gain value will be changed successively to produce a fade-in effect by means of the lookup table. At this moment, a signal for deactivating this dynamic gain mechanism is generated, such as a finish signal. After that, the dynamic gain is recovered to 1 for avoiding any possible influence on the accuracy of modulation.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for minimizing quantization noise as muting, comprising;
receiving signals, wherein a delta-sigma modulator receives the signals inputted from an audio decoder;
detecting signal zeros of the signals by a zero-sampling detection unit disposed in the modulator;
counting the signal zeros of the signals;
determining whether a mute state is entered, if the accumulated signal zeros of the signals do not reach the pre-set number, the zero-sampling detection unit reset the accumulated signal zeros since the signal route maintained in an original route;
if the signal zeros of the signals are accumulated to a pre-set number, a mute state is entered, switching a signal route to a route with a dynamic gain mechanism;
activating the dynamic gain mechanism, when the mute state entered, for generate a dynamic gain; and
feeding back the dynamic gain to an input end of the delta-sigma modulator.

2. The method of claim 1, wherein the dynamic gain for each time is obtained according to a lookup table.

3. The method of claim 1, farther comprising a fade-in effect and a fade-out effect, produced by successively changing the dynamic gain, in the ending and beginning of the mute state respectively.

4. The method of claim 3, wherein the dynamic gain is recovered to all original value as an ideal mute is obtained after a fade-out effect.

5. The method of claim 1, further comprising a detect signal generated to activate the dynamic gain mechanism as the mute state enters; and a finish signal generated to deactivate the dynamic gain mechanism as the mute state ends.

6. The method of claim 5, wherein the zero-sampling detection unit stops controlling a signal generating circuit in the delta-sigma modulator when the mute state ends and the dynamic gain mechanism deactivates.

7. The method of claim 5, wherein the dynamic gain resets when the mute state ends and the dynamic gain mechanism deactivates.

8. An apparatus for minimizing quantization noise as muting, comprising:
a delta-sigma modulator, receiving an audio signal inputted from an audio decoder, executing a digital-to-analog conversion;
a means for producing a dynamic gain, disposed in the delta-sigma modulator, for producing the dynamic gain fed back to an input end of the modulator and tuning the signals; and
a zero-sampling detection unit, coupled to the input end of the delta-sigma modulator, for detecting and counting signal zeros of the signals inputted into the modulator, when the number of the accumulated signal zeros reaches a pre-set number, a mute state is entered and a dynamic gain mechanism is activated.

9. The apparatus of claim 8, wherein the means for producing the dynamic gain is implemented by a lookup table, and the dynamic gain for each time is defined in the lookup table.

10. The apparatus of claim 8, wherein the delta-sigma modulator is formed as a 3-order delta-sigma modulator composed of a plurality of integrators and adders.

11. The apparatus of claim 10, wherein the 3-order delta-sigma modulator includes a quantizer.

12. The apparatus of claim 11, wherein the 3-order delta-sigma modulator further includes a delay unit for fitting the signals outputted from the quantizer.

13. The apparatus of claim 8, wherein the zero-sampling detection unit includes a counter for counting the signal zeros.

14. The apparatus of claim 8, further comprising a multiplexer used to switch the signal route to a route with the dynamic gain mechanism as entering the mute state.

15. The apparatus of claim 8, wherein the means for producing a dynamic gain includes resetting the dynamic gain as the mute state ends.
